(19) United States
(12) Patent Application Publication
(10) Pub. No.: US 2019/0236351 A1
(43) Pub. Date: Aug. 1, 2019

(54) IMAGE PROCESSING APPARATUS AND IMAGE PROCESSING PROGRAM

(71) Applicant: SEIKO EPSON CORPORATION, Tokyo (JP)

(72) Inventor: Kiyoshi MIZUKURA, Shiojiri-shi (JP)

(73) Assignee: SEIKO EPSON CORPORATION, Tokyo (JP)

(21) Appl. No.: 16/262,390

(22) Filed: Jan. 30, 2019

(30) Foreign Application Priority Data
Jan. 31, 2018 (JP) 2018-014569

(51) Int. Cl. G06K 9/00; G06F 3/0485; G06Q 20/20

(52) U.S. Cl. CPC G06K 9/00469; G06K 2209/01; G06Q 20/209; G06F 3/04855

(57) ABSTRACT

Provided are a controller configured to acquire a receipt image having been generated by reading of a receipt and a display section configured to display the receipt image, and the controller recognizes character rows included in the receipt image by performing character recognition processing, specifies an itemized-receipt region inside the receipt image on the basis of the character rows included in the receipt image, omits a region included in the receipt image and located above the upper end side of the itemized-receipt region, and allows a region including a portion or the whole of the itemized-receipt region to be displayed on the display section.

### BACKGROUND

### 1. Technical Field

The present invention relates to an image processing apparatus and a non-transitory computer-readable computer medium storing an image processing program.

### 2. Related Art

Heretofore, there has been known an image processing program that allows a receipt image resulting from imaging a receipt to be displayed on a display and thereby enables confirmation of an itemized receipt included in the receipt image and containing a shop name, amounts for each commodity item, a total amount, and the like (see JP-A-2016-126356).

In such a case, however, when a receipt image is displayed on a display, items having no relation with an itemized receipt, such as advertisements from a vendor, various questionnaires, and the like, are sometimes written on the upper end side and/or the lower end side of a receipt. For this reason, there sometimes occurs a case where the itemized receipt is displayed in a relatively small size inside the receipt image, or the most of the itemized receipt is not displayed inside the screen, thereby making it troublesome for a user to confirm the itemized receipt.

### SUMMARY

An image processing apparatus according to an aspect of the invention includes a controller configured to acquire a receipt image having been generated by reading of a receipt, and a display section configured to display the receipt image, and the controller recognizes character rows included in the receipt image by performing character recognition processing, specifies an itemized-receipt region inside the receipt image on the basis of the character rows included in the receipt image, omits a region included in the receipt image and located above the upper end of the itemized-receipt region, and allows a region including a portion or the whole of the itemized-receipt region to be displayed on the display section.

### BRIEF DESCRIPTION OF THE DRAWINGS

The invention will be described with reference to the accompanying drawings, wherein like numbers reference like elements.

FIG. 1 is a diagram illustrating a configuration of an image processing apparatus in a simplified manner.

FIG. 2 is a flowchart illustrating processing according to a first embodiment.

FIG. 3 is a diagram illustrating an example of a receipt.

FIG. 4 is a diagram illustrating an example of a setting screen.

FIG. 5A is a diagram illustrating an example of a display form of a receipt image in a receipt display field, and FIG. 5B is a diagram illustrating another example of the display form of the receipt image in the receipt display field.

FIG. 6A is a diagram illustrating an example of a conventional display form of a receipt image in a receipt display field, and FIG. 6B is a diagram illustrating another example of the conventional display form of the receipt image in the receipt display field.

FIG. 7 is a flowchart illustrating a flowchart according to a second embodiment.

FIG. 8 is a diagram illustrating an example of a setting screen according to a third embodiment.

FIG. 9 is a diagram illustrating an example of a setting screen according to fourth and fifth embodiments.

### DESCRIPTION OF EXEMPLARY EMBODIMENTS

Hereinafter, some embodiments of the invention will be described referring to the individual figures. Note that the individual figures are just exemplifications for describing the present embodiments.

### 1. Schematic Description of Apparatus Configuration

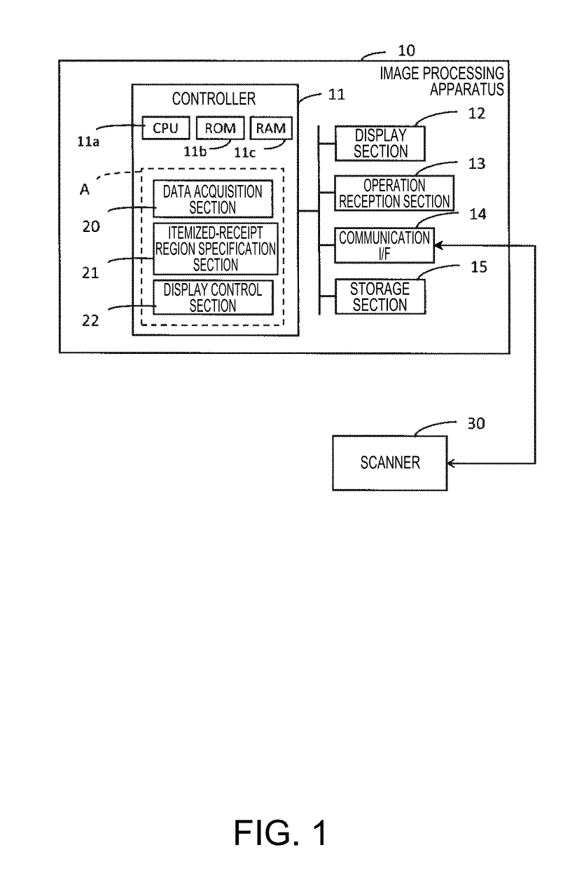

FIG. 1 illustrates a configuration of an image processing apparatus 10, namely, an image processing apparatus according to the present embodiments, in a simplified manner. The image processing apparatus 10 is communicably connected to a reading apparatus (a scanner 30) configured to optically read a document, generate image data having a predetermined format, as a result of the reading, and output the image data to the outside. Any apparatus among apparatuses functioning as image reading apparatuses including commonly known products thereof may be employed as the scanner 30.

The image processing apparatus 10 is implemented using, for example, a personal computer (PC), a smart phone, a tablet terminal, a mobile phone, or any other image processing apparatus having the same level of processing ability as that of any one of the above-exemplified devices. Further, hardware capable of implementing a controller 11 and a display section 12, namely, a controller and a display section according to the present embodiments, may be referred to as the image processing apparatus.

The image processing apparatus 10 includes the controller 11, the display section 12, an operation reception section 13, a communication interface (IF) 14, a storage section 15, and the like. The controller 11 is configured to appropriately include a single IC or a plurality of ICs that includes a processor (which may be, for example, a CPU 11a, an ASIC, or a device including an ASIC, a CPU and the like that operate in cooperation with one another), a ROM 11b, a RAM 11c, and the like; any other memory; and the like. The storage section 15 is a non-volatile storage device, such as a hard disk drive (HDD), a flash memory, or the like. The storage section 15 may be a portion of the controller 11.

The controller 11 controls the image processing apparatus 10 in such a way that the processor (the CPU 11a) executes arithmetic processing following programs stored in the ROM 11b, the storage section 15, and the like, using the RAM 11c and the like as a work area. The controller 11 includes a program A, namely, a program having been installed therein as one of the programs, and the controller 11 implements, by its execution following the program A, the individual functions of a data acquisition section 20, an itemized-receipt region specification section 21, a display control section 22, and the like. The program A is an image processing program that allows a computer to execute processing on a receipt image having been generated by reading of a receipt. Further, the program A is an application program for storing and managing the receipt image.

The communication IF 14 is an IF that complies with a predetermined protocol among communication protocols including commonly known communication protocols and that executes communication with the outside via a wired link or a wireless link. In the example of FIG. 1, the image processing apparatus 10 is connected to the scanner 30 via the communication IF 14. The image processing apparatus 10 is also capable of being connected to an external network via the communication IF 14 or another unillustrated communication IF, and the controller 11 is also capable of uploading image data having been acquired from the scanner 30 to an unillustrated external server through the above external network (a local area network, an Internet communication network, or the like).

The display section 12 is a means for displaying visual information, and is constituted by, for example, a liquid crystal display (LCD), an organic EL display, or the like. The display section 12 may be configured to include a display and a driving circuit for driving the display. The operation reception section 13 is a means for receiving operations by a user, and is implemented using, for example, physical buttons, a touch panel, a mouse device, a keyboard, and/or the like. Naturally, the touch panel may be implemented as one of the functions of the display section 12. Further, the display section 12 and the operation reception section 13 can be collectively referred to as an operation panel or the like.

A partial configuration illustrated in FIG. 1, that is, the operation reception section 13, the storage section 15, or the like may be a peripheral device that is externally connected to the image processing apparatus 10. Further, a configuration including the image processing apparatus 10 and the scanner 30, which are illustrated in FIG. 1, can be treated as a single system. Alternatively, for the image processing apparatus 10 and the scanner 30, the whole of these apparatuses may be included in a single apparatus as their actual conditions. In the case where the image processing apparatus 10 and the scanner 30 are included in a single apparatus, such a single apparatus can be referred to a reading apparatus or the like. Further, the configuration including the image processing apparatus 10 and the scanner 30 may be a multifunction machine integrally having a plurality of functions as a printer (a copy machine), a facsimile machine, and the like.

### 2. Display Processing for Receipt Image

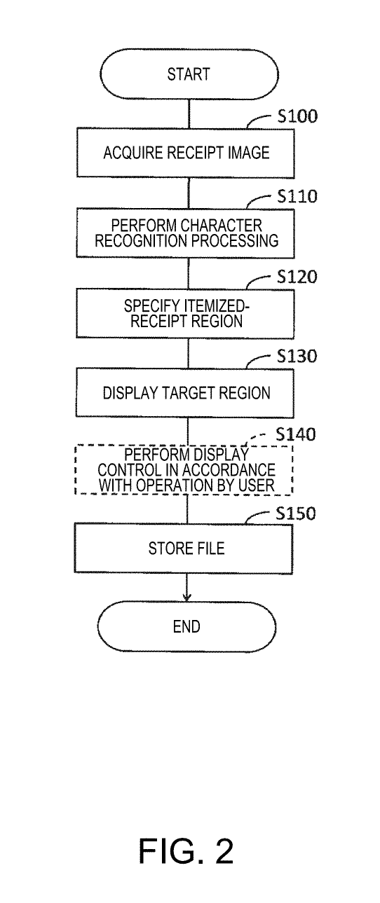

FIG. 2 indicates processing of the execution following the program A and implemented by the controller 11, by way of a flowchart. The flowchart of FIG. 2 includes processing for displaying a receipt image. An embodiment described in accordance with the flowchart of FIG. 2 is also referred to as a first embodiment.

The scanner 30 reads a document having been optionally set by a user, and generates image data. In the present embodiment, the document, which the user allows the scanner 30 to read, is assumed to be a receipt 40. This receipt 40 is a receipt having been issued by a shop at which the user has made a purchase. The scanner 30 transmits the image data as a result of the reading of the receipt 40 to the image processing apparatus 10. In the present embodiment, the image data, as a result of the reading of the receipt 40, will be referred to as a receipt image hereinafter. The controller 11 may be configured to instruct the scanner 30 to start the reading of the document via the communication IF 14, and the scanner 30 may be configured to, in accordance with the reading-start instruction from the controller 11, start the reading of the document (the receipt 40).

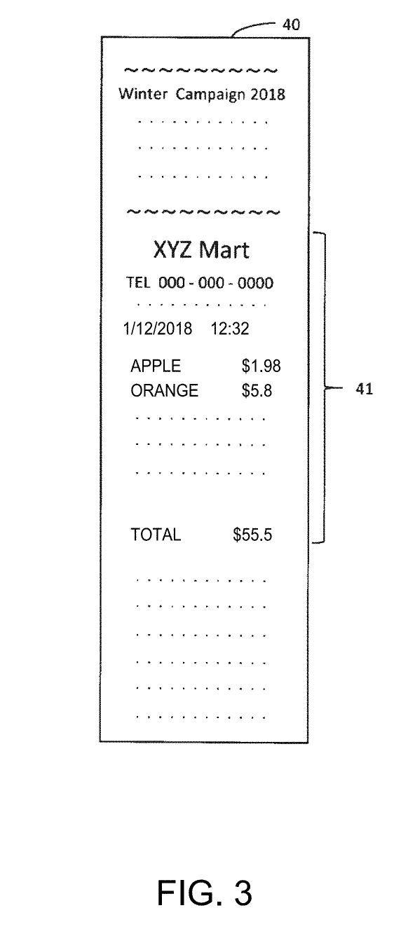

FIG. 3 illustrates an example of the receipt 40, which a user has allowed the scanner 30 to read. On the receipt 40, there are written items, such as a shop name, namely, the issue source of the receipt 40; an issue date; contact destination information about the shop; amounts for each article and each service that have been purchased by the user (namely, amounts for each commodity item); a total amount having been paid by the user; and the like. In addition thereto, various pieces of information, such as advertisements, various questionnaires, the total number of points possessed by the user, and the like, may be further written on the receipt 40.

The data acquisition section 20 acquires the receipt image, which, as described above, has been transmitted from the scanner 30, via the communication IF 14 (step S100). Here, the data acquisition section 20 may be configured not to acquire (receive) the receipt image directly from the scanner 30, but to acquire the receipt image from a storage section (for example, the storage section 15) serving as a transfer destination to which the receipt image has been transferred from the scanner 30.

The itemized-receipt region specification section 21 performs processing for an optical character recognition/reader (OCR), that is, character recognition processing, on the receipt image having been acquired by the data acquisition section 20 in step S100, and thereby recognizes character rows included in the receipt image (step S110). In this case, the itemized-receipt region specification section 21 converts the character rows and recognizable objects, both of which are included in the receipt image, into character data (text data). Here, the character recognition processing is omitted from description because the character recognition processing is a commonly known technique.

In step S120, the itemized-receipt region specification section 21 specifies an itemized-receipt region inside the receipt image on the basis of the character rows included in the receipt image and having been recognized in step S110 (the relevant character rows included in the receipt image being referred to as intra-image character rows hereinafter). The itemized-receipt region is a region inside which there are written character rows corresponding to predetermined items, such as a shop name, amounts for each commodity item, a total amount, and the like. The itemized-receipt region specification section 21 extracts such character rows, which correspond to the items included in the itemized-receipt region, from among the intra-image character rows, and specifies a region inside which the extracted character rows are written, as the itemized-receipt region.

More specifically, the itemized-receipt region specification section 21 extracts a first character row corresponding to a predetermined first item and a second character row corresponding to a predetermined second item from among the intra-image character rows, and specifies a region included in the receipt image and extending from the first character row up to the second character row, as the itemized-receipt region. In the receipt, mostly, the amounts for each commodity item are written between the shop name and the total amount. Thus, as an example, the first item and the second item are respectively assumed to be the shop name and the total amount.

The itemized-receipt region specification section 21 refers to, for example, a shop-name list having been stored in advance in the storage section 15 or the like, and thereby extracts a character row coinciding with any one of shop names included in the shop-name list or a character row including any one of the shop names included in the shop-name list, as the first character row corresponding to the first item (the shop name). In the shop-name list, for example, there are recorded shop names each having been previously stored together with a receipt image by means of the function of the program A. Further, the itemized-receipt region specification section 21 extracts a character row including a specific word, such as “sum”, “total”, “sales amount”, or the like, and numeric characters that are written in a field following the specific word and that indicate a money amount, from among the intra-image character rows, as the second character row corresponding to the second item (the total amount). The itemized-receipt region specification section 21 is also capable of extracting a range within which character rows included in the intra-image character rows and corresponding to combinations of the name of an article or a service and numeric characters indicating a money amount are arranged in parallel in an upper-lower direction of the receipt image, as character rows indicating the amounts for each commodity item. Further, the itemized-receipt region specification section 21 determines that the first character row is the beginning row of the itemized receipt and the second character row is the end row of the itemized-receipt, and specifies a region included in the receipt image and extending from the beginning row up to the end row of the itemized receipt, as the itemized-receipt region. Referring to FIG. 3, a range 41, namely, a range included in the receipt 40 and extending from a row at which a shop name “XYZ Mart” is written up to a row at which “TOTAL $55.0” is written, corresponds to the itemized-receipt region inside the receipt image.

In step S130, the display control section 22 allows a region that is included in the receipt image and that is obtained by omitting the upper end of the receipt image and includes a portion or the whole of the itemized-receipt region, having been specified in step S120, to be displayed on the display section 12. The region included in the receipt image and allowed to be displayed on the display section 12 in step S130 will be also referred to as “a target region” for the sake of convenience of description.

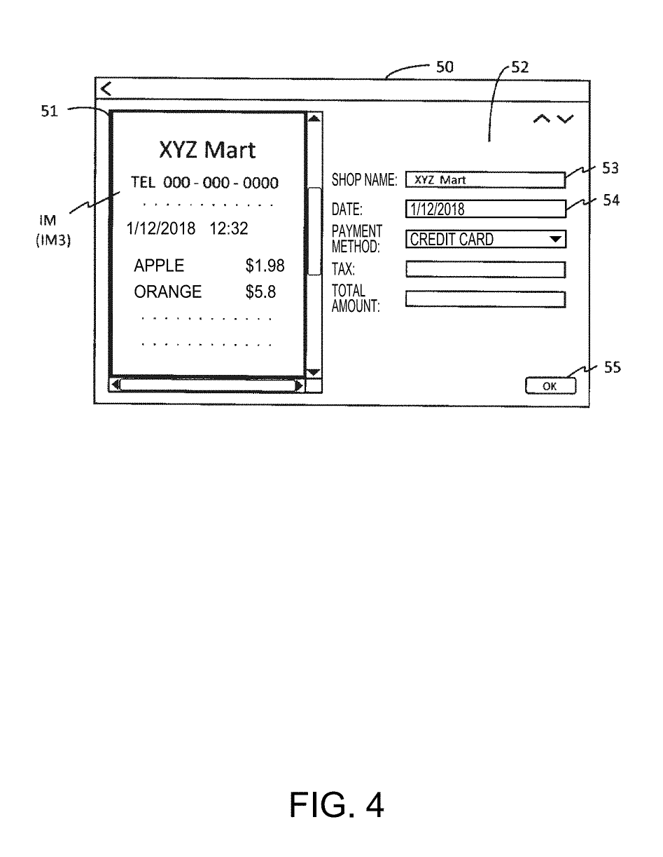

FIG. 4 illustrates an example of a setting screen 50, namely, a setting screen that is displayed on the display section 12 in step S130 by the display control section 22. The setting screen 50 includes a receipt display field 51, namely, a receipt display field for displaying the receipt image; an itemized-receipt display field 52, namely, an itemized-receipt display field for displaying character rows corresponding to a plurality of items included in the itemized-receipt region; a save button (an OK button) 55; and the like. A receipt image IM, namely, the receipt image having been acquired in step S100, is displayed in the receipt display field 51. A user is able to make visual confirmation of the receipt 40, which the user has allowed the scanner 30 to read, through the receipt display field 51. In this regard, however, in step S130, a target region IM3, namely, a target region of the receipt image IM, is displayed in the receipt display field 51

The itemized-receipt display field 52 includes an issue source setting field 53, an issue date setting field 54, and other fields. The issue source setting field 53 is a field for use in setting the issue source of the receipt (namely, a shop name, a vendor name, or the like); the issue date setting field 54 is a field for use in setting the date of the issue of the receipt; and the other fields are fields for use in setting a payment method for charged money, a tax amount, a total amount of the charged money, and the like. A user is able to optionally perform inputting and editing on the individual setting fields of the itemized-receipt display field 52 by operating the operation reception section 13 or the like. Further, the controller 11 may be configured to extract individual kinds of information (character rows), such as a shop name, a date, a total amount, and the like, from among the intra-image character rows having been recognized in step S110, and automatically display each of the extracted character rows in a corresponding one of the setting fields of the itemized-receipt display field 52.

The operation in which the setting screen 50 configured in such a way as described above is displayed on the display section 12 corresponds to the operation in which the target region IM3 is displayed on the display section 12. From a viewpoint of a user, at the time when the setting screen 50 has been displayed on the display section 12, the target region IM3, which is a target region of the receipt image IM, is displayed in the receipt display field 51.

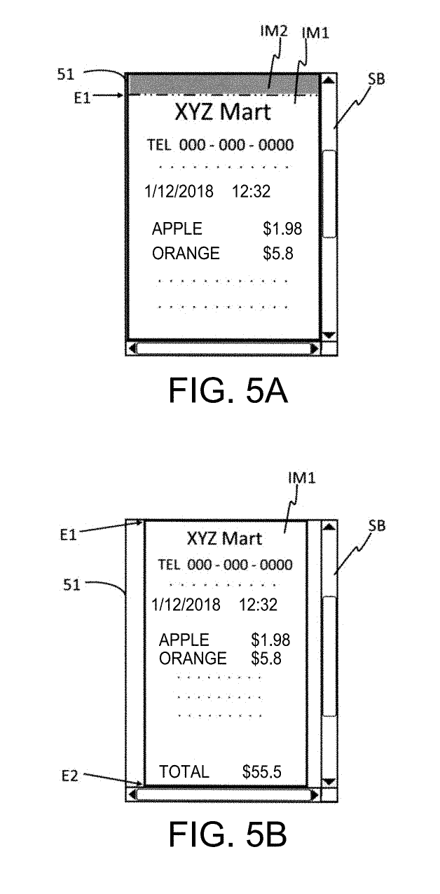

In each of FIGS. 5A and 5B, the receipt display field 51 at the time when the display control section 22 has allowed the setting screen 50 to be displayed on the display section 12 in step S130 is extracted and exemplified. The display control section 22 may employ any one of the display forms of FIGS. 5A and 5B.

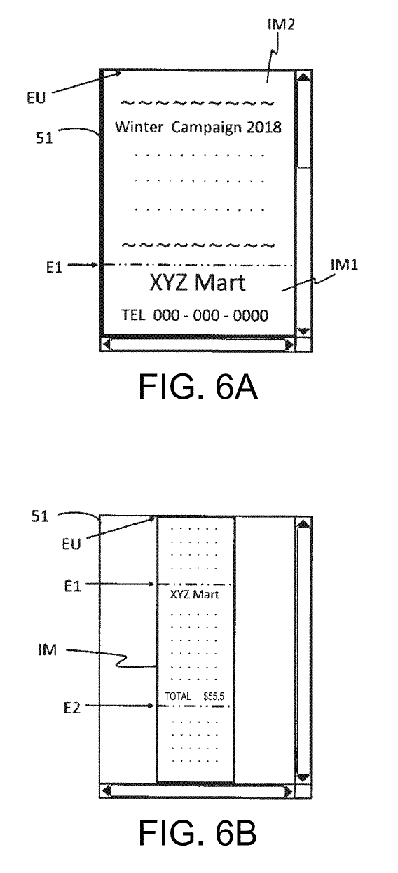

FIG. 5A is an example in which a portion of the receipt image IM is displayed in the receipt display field 51 in a size determined in such a way that the short sides (sides directed in a lateral direction) of the receipt image IM having long sides in the upper-lower direction correspond to the short sides (sides directed in the lateral direction) of the receipt display field 51. Meanwhile, FIG. 5B is an example in which a portion of the receipt image IM is displayed in the receipt display field 51 in a size determined in such a way that a range from an upper end E1 up to a lower end E2, that is, a range from the upper end up to the lower end of an itemized-receipt region IM1, in the upper-lower direction of the receipt image IM corresponds to the long sides (sides directed in the upper-lower direction) of the receipt display field 51. Note that, in FIG. 5A, and FIGS. 6A and 6B described below, the positions of the upper end E1 and the lower end E2 of the itemized-receipt region IM1 are represented by chain double-dashed lines, but such chain double-dashed lines representing the upper end E1 and the lower end E2 do not actually exist on the receipt 40.

In FIG. 5A, a partial image that is included in an image displayed in the receipt display field 51 and that is located above and adjacent to the upper end E1 is a portion of a non-itemized-receipt region IM2, namely, a non-itemized-receipt region included in the receipt image IM and not corresponding to the itemized-receipt region IM1, having been specified in step S120. In FIG. 5A, an image other than the non-itemized-receipt region IM2 in the image displayed in the receipt display field 51 corresponds to a portion of the itemized-receipt region IM1, having been specified in step S120. In FIG. 5A, the non-itemized-receipt region IM2 displayed in the receipt display field 51 is just a portion adjacent to the upper end E1 of the itemized-receipt region IM1, and is an image not including an upper end EU, namely, the upper end of the receipt image IM.

Accordingly, the image displayed in the receipt display field 51 and illustrated in FIG. 5A corresponds to an example of a region that is included in the receipt image IM and that is obtained by omitting the upper end EU and includes a portion or the whole of the itemized-receipt region IM1, having been specified in step S120, that is, the relevant image displayed in the receipt display field 51 corresponds to an example of the target region IM3. Note that the image inside the receipt display field 51 of FIG. 5A is the same as the image inside the receipt display field 51 of FIG. 4. A reason why the non-itemized-receipt region IM2 of the image inside the receipt display field 51 of FIG. 5A is represented by gray color will be described later.

The display control section 22 may be configured to, when displaying, in step S130, a portion of the receipt image IM in the receipt display field 51 in a size determined in such a way that, as illustrated in FIG. 5A, the short sides of the receipt image IM correspond to the short sides of the receipt display field 51, allow the position of the upper end E1 of the itemized-receipt region IM1 to correspond to that of the upper end of the receipt display field 51 so as to cause the non-itemized-receipt region IM2, which is located above and adjacent to the upper end E1, not to be displayed in the receipt display field 51. An image displayed in the receipt display field 51 in this way, that is, in such a way that the image inside the receipt display field 51 is in a state of allowing the upper end E1 of the itemized-receipt region IM1 to correspond to the upper end of the receipt display field 51, also corresponds to the above region (namely, the target region IM3), which is included in the receipt image IM and which is obtained by omitting the upper end EU and includes a portion or the whole of the itemized-receipt region IM1, having been specified in step S120.

In FIG. 5B, the upper end E1 of the itemized-receipt region IM1 corresponds to the upper end of the receipt display field 51, and the lower end E2 of the itemized-receipt region IM1 corresponds to the lower end of the receipt display field 51, and as a result, the whole of the itemized-receipt region IM1 is displayed in the receipt display field 51. Accordingly, the image displayed in the receipt display field 51 and illustrated in FIG. 5B also corresponds to the above region (namely, the target region IM3), which is included in the receipt image IM and which is obtained by omitting the upper end EU and includes a portion or the whole of the itemized-receipt region IM1, having been specified in step S120.

That is, the target region IM3 is a partial region included in the receipt image IM and satisfying a condition that the relevant partial region does not include the upper end EU of the receipt image IM and includes a portion or the whole of the itemized-receipt region IM1, and the target region IM3 may correspond to any one of regions: the whole of the itemized-receipt region IM1; a portion of the itemized-receipt region IM1; the whole of the itemized-receipt region IM1 and a portion of the non-itemized-receipt region IM2; and a portion of the itemized-receipt region IM1 and a portion of the non-itemized-receipt region IM2. Further, as one display form of the present embodiment, the target region IM3 may be defined as a region that includes a portion or the whole of the itemized-receipt region IM1 and that does not include the upper end EU of the receipt image IM and includes the upper end E1 of the itemized-receipt region IM1.

Each of FIGS. 6A and 6B exemplifies a conventional display form of the receipt image IM on the display section 12. Heretofore, an application program for performing processing on a receipt image has been configured to, when displaying a portion of the receipt image IM in the receipt display field 51 in a size determined in such a way that, as illustrated in FIG. 6A, the short sides of the receipt image IM correspond to the short sides of the receipt display field 51, allow the position of the upper end EU of the receipt image IM to correspond to that of the upper end of the receipt display field 51. That is, the application program has been configured to allow the upper end EU of the receipt image IM to be displayed. For this reason, as a result, most or all of portions of the receipt display field 51 are occupied by the non-itemized-receipt region IM2, which is located above and adjacent to the itemized-receipt region IM1, and thus, in order to confirm the itemized-receipt region IM1 on the screen, a user has had to perform an operation of downwardly scrolling the image inside the receipt display field 51 to allow the itemized-receipt region IM1 to be displayed.

Further, heretofore, the application program for performing processing on the receipt image has been configured to display the whole of the receipt image IM in the receipt display field 51 in such a way that, as illustrated in FIG. 6B, the position of the upper end EU of the receipt image IM corresponds to that of the upper end of the receipt display field 51 and the position of the lower end of the receipt image IM corresponds to that of the lower end of the receipt display field 51. In this case, the itemized-receipt region (the region from the upper end E1 up to the lower end E2), which is a portion of the receipt image IM, is in a state being displayed in a relatively small size and thus being almost invisible in the receipt display field 51, and thus, in order to confirm the itemized-receipt region IM1 on the screen, the user has had to perform an operation of increasing the display magnification of the image inside the receipt display field 51.

In contrast to such conventional examples (FIGS. 6A and 6B), in the present embodiment, as illustrated in the examples of FIGS. 4, 5A, and 5B, at the time when the setting screen 50 has been displayed on the display section 12 in step S130, most or all of portions of the itemized-receipt region IM1 are displayed in the receipt display field 51. Further, in the present embodiment, the itemized-receipt region IM1 is enlarged and displayed, as compared with the display form illustrated in FIG. 6B, which causes the whole of the receipt image IM to be displayed. For this reason, the user is able to easily make visible confirmation of the itemized-receipt region IM1 of the receipt image IM through the receipt display field 51 without performing such a troublesome operation.

In the state in which the display control section 22 has allowed the setting screen 50 to be displayed on the display section 12 in such a way as described above, upon receipt of an optional operation by a user via the operation reception section 13, the display control section 22 performs display control in accordance with the received operation (step S140). For example, upon receipt of a character input to each of the setting fields of the itemized-receipt display field 52, the display control section 22 displays a character row in the each setting field in accordance with the received character input. Further, upon receipt of an operation on a scroll bar SB (see FIG. 5), namely, a scroll bar having been displayed together with the receipt display field 51, the display control section 22 scrolls a display inside the receipt display field 51 in accordance with the operation on the scroll bar SB.

Upon receipt of a predetermined operation of terminating the setting inputs onto the setting screen 50, that is, for example, an operation onto the OK button 55, from a user, the controller 11 stores the receipt image having been acquired in step S100 into the storage section 15 or the like, as a file (step S150), and closes the setting screen 50 to terminate the flowchart of FIG. 2. When storing the receipt image as a file, the controller 11 stores the receipt image together with current setting contents (displayed contents) in the respective setting fields of the itemized-receipt display field 52. The user is able to edit the setting contents having been stored together with the receipt image when needed by opening the setting screen 50 again.

In this way, according to the present embodiment, the image processing apparatus 10 includes the controller 11 configured to acquire a receipt image having been generated by the reading of the receipt 40 (step S100), and to allow the receipt image to be displayed on the display section 12. The controller 11 is configured to, by its execution following the program A, recognize character rows included in the receipt image (namely, intra-image character rows) by performing character recognition processing (step S110); specify an itemized-receipt region inside the receipt image on the basis of the intra-image character rows (step S120); and allow a region (a target region) that is included in the receipt image and that is obtained by omitting the upper end of the receipt image and includes a portion or the whole of the itemized-receipt region to be displayed on the display section 12 (step S130). As a result of this process, the itemized-receipt region that is an important region for a user in the receipt image is displayed on the display section 12 in a state in which the user is able to easily make visible confirmation, thereby enabling the user to easily confirm the itemized-receipt region.

Further, according to the present embodiment, the controller 11 extracts a first character row corresponding to a predetermined first item (for example, a shop name) and a second character row corresponding to a predetermined second item (for example, a total amount) from among the intra-image character rows, and specifies a region included in the receipt image and extending from the first character row up to the second character rows as an itemized-receipt region (step S120). According to the above configuration, the controller 11 is capable of easily specifying the itemized-receipt region by extracting character rows corresponding to a plurality of predetermined items included in the itemized-receipt region.

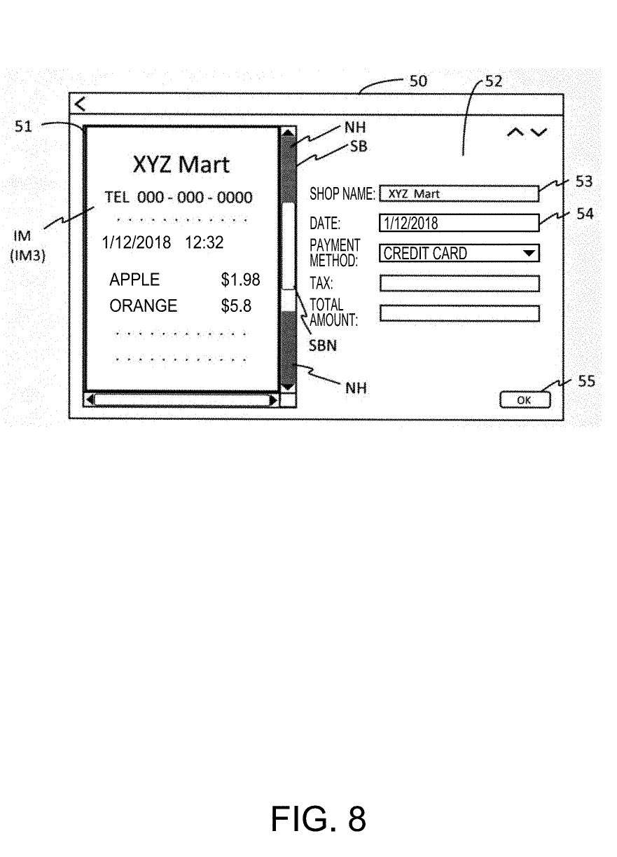

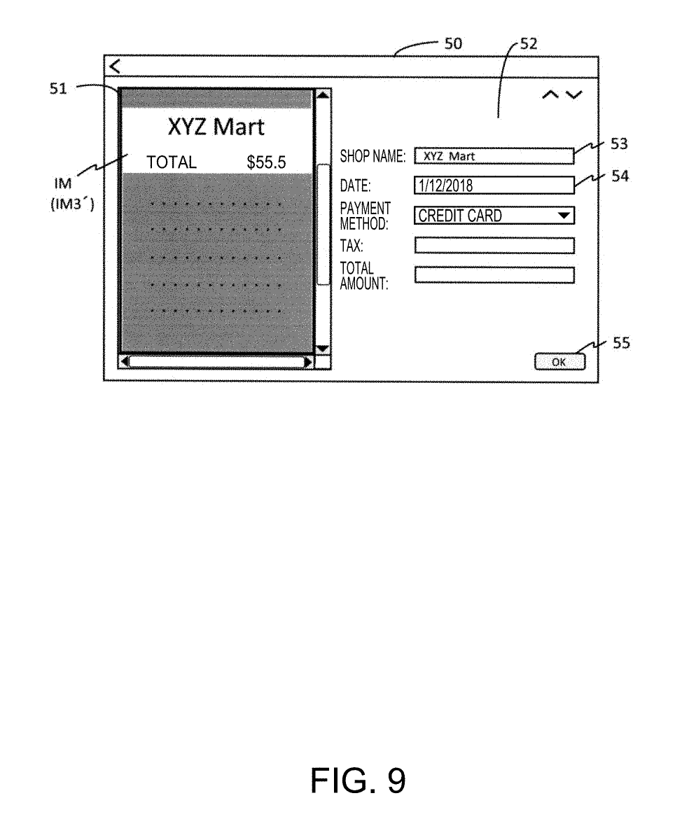

Further, according to the present embodiment, the controller 11 allows the setting screen 50, which includes the receipt display field 51 for use in displaying the receipt image, and the itemized-receipt display field 52 for use in displaying the character rows corresponding to the respective plurality of items included in the itemized-receipt region, to be displayed on the display section 12. According to this configuration, a user is able to perform, within a single screen, both of the confirmation of the itemized-receipt region inside the receipt image and the setting of individual items for the receipt 40, such as an issue source, an issue date, and the like. In this regard, however, FIG. 4, and FIGS. 8 and 9 described later are just examples of a screen for displaying the target region, which is a portion of the receipt image. The screen for displaying the target region has a variety in its layout, its design, and its roll, and the receipt display field 51 and the itemized-receipt display field 52 may be configured to be displayed on mutually different screens.

As obvious from the description having been made so far, the program A serving as an image processing program allows the processor to execute the control function that allows the receipt image to be displayed on the display section 12. Further, it can be said that the present embodiment also discloses a method corresponding to processing by the image processing program, and a storage medium storing therein the image processing program and being readable from a computer.

The present embodiments include not only the above-described display forms, but also various display forms described below. The configurations resulting from appropriately combining embodiments among the present embodiments are also included within the scope of the disclosure by the present specification. In the following description, description items common to the already-described description items will be omitted as needed.

### 3. Second Embodiment

The controller 11 may be configured to be executable for both of a whole display that allows the whole of the receipt image to be displayed on the display section 12, and a partial display that allows a target region to be displayed on the display section 12, and to execute either the whole display or the partial display in accordance with an instruction from the outside.

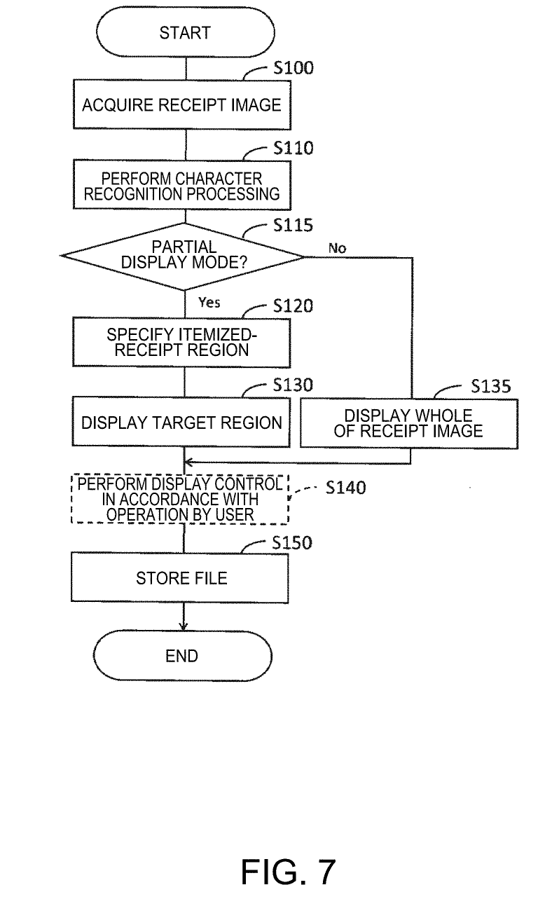

FIG. 7 illustrates processing according to this second embodiment with respect to the execution following the program A and implemented by the controller 11, by way of a flowchart. As an assumption on the execution of the flowchart of FIG. 7, the controller 11 has already enabled either a partial display mode or a whole display mode in accordance with an instruction from a user. The whole display mode is disabled in a state in which the partial display mode is enabled; while in contrast, the partial display mode is disabled in a state in which the whole display mode is enabled. In the present embodiment, the controller 11 has already enabled the partial display mode in a default setting. Thus, the partial display mode remains in a state being enabled unless the whole display mode is enabled by a user.

When compared with the flowchart of FIG. 2, the flowchart of FIG. 7 is different in that steps S115 and S135 are included. Subsequent to step S110, the controller 11 determines whether or not the partial display mode is currently enabled (step S115), and in the case where the partial display mode is enabled, the controller 11 allows the process flow to proceed to step S120 from step S115. In contrast, in the case where the partial display mode is disabled, that is, the whole display mode is enabled, the controller 11 allows the process flow to proceed to step S135 from step S115.

In step S135, the display control section 22 allows the whole of the receipt image having been acquired in step S100 to be displayed on the display section 12. That is, as exemplified in FIG. 6B, the display control section 22 allows the whole of the receipt image IM to be displayed in the receipt display field 51 of the setting screen 50. According to this second embodiment configured in such a way as described above, the controller 11 is capable of allowing the whole of the receipt image to be displayed on the display section 12 or allowing the target region to be displayed on the display section 12 in accordance with an optional selection by a user. Note that all of third to fifth embodiments described below are embodiments that, when combined with the second embodiment, are in a state in which the partial display mode is enabled.

### 4. Third Embodiment

The controller 11 allows a scroll bar SB to be displayed on the display section 12. Further, the controller 11 may be configured to allow a first range of the scroll bar SB and a second range of the scroll bar SB to be displayed in mutual different display forms, the first range being associated with the itemized-receipt region, the second range being associated with a region being included in the receipt image and being other than the itemized-receipt region (namely, the non-itemized-receipt region).

FIG. 8 exemplifies a setting screen 50, namely, a setting screen displayed on the display section 12 in step S130 in this third embodiment. In the setting screen 50, the scroll bar SB is additionally displayed inside the receipt display field 51. The scroll bar SB illustrated in FIG. 8 is a graphical user interface (GUI) for scrolling an image inside the receipt display field 51 in the upper-lower direction. A user allows the image inside the receipt display field 51 to be scrolled in the upper-lower direction by operating the operation section 13 to move a knob SBN within an area of the scroll bar SB. A ratio of the length of the knob SBN relative to the length of the area of the scroll bar SB within which the knob SBN is capable of moving represents a ratio of the upper-lower direction length of the image displayed in the receipt display field 51 relative to the upper-lower direction length of the receipt image.

For example, in the area of the scroll bar SB within which the knob SBN is capable of moving, the display control section 22 displays a range NH, namely, a range corresponding to the non-itemized-receipt region, in color darker than the color of a range corresponding to the itemized-receipt region. In other words, in the area of the scroll bar SB within which the knob SBN is capable of moving, the display control section 22 displays the range corresponding to the itemized-receipt region in color brighter than the color of the range NH corresponding to the non-itemized-receipt region. With this configuration, a user is able to intuitively understand to which position in the area of the scroll bar SB the user needs to move the knob SBN to allow the itemized-receipt region to be displayed in the receipt display field 51, and thus, this configuration helps the user who desires to confirm the itemized-receipt region through the receipt display field 51.

### 5. Fourth Embodiment

The controller 11 may be configured to allow a region having been generated by omitting one or more character rows each associated with a corresponding one of one or more items that are among a plurality of items included in an itemized-receipt region and that are not selected in advance to be displayed on the display section 12. The plurality of items included in the itemized-receipt region corresponds to a shop name, amounts for each commodity item, a total amount, and the like. As an example, it is assumed that a user has operated the operation reception section 13 in such a way that the shop name and the total amount are selected as items inside the itemized-receipt region that are to be displayed in the receipt display field 51 and the amounts for each commodity item are not selected, and the user has already instructed the result of this selection to the controller 11.

FIG. 9 exemplifies a setting screen 50, namely, a setting screen displayed on the display section 12 in step S130 in this fourth embodiment. In the receipt display field 51 inside the setting screen 50, a target region IM3′, namely, a target region that is included in the receipt image IM resulting from the omission of the upper end of the receipt image IM and that includes a portion of an itemized-receipt region (namely, a regenerated itemized-receipt region described below) is displayed. In the course of specifying the itemized-receipt region in step S120, the display control section 22 regenerates an image of the itemized-receipt region in such a way as to, as described above, allow one or more items that are selected in advance by a user (namely, the shop name and the total amount) to remain, and omit one or more items that are not selected in advance by the user (namely, the amounts for each commodity item). Further, the display control section 22 performs display inside the receipt display field 51 on the basis of a receipt image resulting from a combination having been made in such a way that the regenerated image of the itemized-receipt region is interposed between upper and lower non-itemized-receipt regions (that is, on the basis of a receipt image resulting from the regeneration). As the result of this processing, the target region IM3′, such as illustrated in FIG. 9, is displayed inside the receipt display field 51. The target region IM3′, illustrated in FIG. 9, is an image including the itemized-receipt region resulting from the regeneration and including only a character row “XYZ Mart” as the shop name and a character row as the total amount.

According to this fourth embodiment configured in such a way as described above, an itemized-receipt region including only one or more character rows each associated with a corresponding one of one or more items having been selected in advance by a user as one or more items inside the itemized-receipt region is displayed in the receipt display field 51, and thus, a user is able to efficiently confirm, through the receipt display field 51, one or more items that are among items written on the receipt 40 having a long length in the upper-lower direction and that are desired to confirm by the user himself or herself. Note that, in this fourth embodiment, the regenerated itemized-receipt region such as described above is an image intended only to allow the user to make visual confirmation through the display section 12. The controller 11 may be configured to, in step S150, store the receipt image including the itemized-receipt region before the regeneration, that is, the itemized-receipt region before the omission of the character rows corresponding to the respective one or more items having been not selected by the user (namely, the amounts for each commodity item).

### 6. Fifth Embodiment

The controller 11 may be configured to display the itemized-receipt region on the display section 12 in a display form different from that for the region being included in the receipt image and being other than the itemized-receipt region (namely, the non-itemized-receipt region). In FIG. 9, the non-itemized-receipt region of the target region IM3′ inside the receipt display field 51 is represented by gray color as an example. Further, in FIG. 5A, the non-itemized-receipt region IM2 of the image inside the receipt display field 51 (namely, the target region IM3) is represented by gray color. Such gray color indicates that the display control section 22 gray-out displays the non-itemized-receipt region in the process of step S130. Naturally, it is just an example that the non-itemized-receipt region is gray-out displayed, and the display control section 22 may be configured not to actually display the non-itemized-receipt region in the receipt display field 51 by replacing the non-itemized-receipt region by a white image. Further, the display control section 22 may be configured to allow the itemized-receipt region to be more noticeable than the non-itemized-receipt region by changing the brightness and/or the color of the itemized-receipt region in the receipt display field 51. According to this fifth embodiment configured in such a way as described above, a user is able to distinctly recognize the itemized-receipt region inside the receipt image through the display section 12.

### 7. Sixth Embodiment

The controller 11 may be configured to separate the image of the itemized-receipt region from the receipt image, and store the separated image of the itemized-receipt region into a storage section (for example, the storage section 15). That is, in step S150, when storing the receipt image having been acquired in step S100 as a file, the controller 11 does not store the whole of the receipt image, but separates the itemized-receipt region from the receipt image having been specified in step S120, and stores only the image of the itemized-receipt region, together with the setting contents in the respective setting fields of the itemized-receipt display field 52. According to this sixth embodiment configured in such a way as described above, the consumption of a storage capacity needed to store the receipt image can be reduced.

This application claims priority to Japanese Application No. 2018-014569, filed 31 Jan. 2018, the entirety of which is incorporated by reference herein.

What is claimed is:

1. An image processing apparatus comprising:
a controller configured to acquire a receipt image having been generated by reading of a receipt; and
a display section configured to display the receipt image,
wherein the controller recognizes character rows included in the receipt image by performing character recognition processing, specifies an itemized-receipt region inside the receipt image based on the character rows included in the receipt image, omits a region included in the receipt image and located above an upper end side of the itemized-receipt region, and allows a region including a portion or a whole of the itemized-receipt region to be displayed on the display section.

2. The image processing apparatus according to claim 1, wherein the controller extracts a first character row corresponding to a predetermined first item and a second character row corresponding to a predetermined second item from among the character rows included in the receipt image, and specifies a region included in the receipt image and extending from the first character row up to the second character row as the itemized-receipt region.

3. The image processing apparatus according to claim 2, wherein the first item corresponds to a shop name, and the second item corresponds to a total amount.

4. The image processing apparatus according to claim 1, wherein the controller allows a region having been generated by omitting at least one character row corresponding to at least one item that is among a plurality of items included in the itemized-receipt region and that is not selected in advance to be displayed on the display section.

5. The image processing apparatus according to claim 1, wherein the controller allows a scroll bar to be displayed on the display section, and allows a first range of the scroll bar and a second range of the scroll bar to be displayed in mutually different display forms, the first range being associated with the itemized-receipt region, the second range being associated with a region being included in the receipt image and being other than the itemized-receipt region.

6. The image processing apparatus according to claim 1, wherein the controller allows the itemized-receipt region to be displayed on the display section in a display form different from a display form of a region being included in the receipt image and being other than the itemized-receipt region.

7. The image processing apparatus according to claim 1, wherein the controller is executable for both of a whole display that allows a whole of the receipt image to be displayed on the display section, and a partial display that allows a region included in the receipt image and located above the upper end side of the itemized-receipt region to be omitted, and allows a region including a portion or a whole of the itemized-receipt region to be displayed on the display section, and the controller executes either the whole display or the partial display in accordance with an instruction from an outside.

8. The image processing apparatus according to claim 1, wherein the controller allows a screen including a receipt display field for displaying the receipt image and an itemized-receipt display field for displaying character rows corresponding to a plurality of items included in the itemized-receipt region to be displayed on the display section.

9. The image processing apparatus according to claim 1, wherein the controller separates an image of the itemized-receipt region from the receipt image, and allows the separated image of the itemized-receipt region to be stored in the storage section.

10. A non-transitory computer-readable computer medium storing an image processing program allowing a computer to execute processing on a receipt image having been generated by reading of a receipt, the image processing program being configured to execute a control function of allowing the receipt image to be displayed on a display section, the control function being configured to recognize character rows included in the receipt image by allowing character recognition processing to be performed, specify an itemized-receipt region inside the receipt image based on the character rows included in the receipt image, omit an upper end side of the receipt image in the receipt image, and allow a region including a portion or a whole of the itemized-receipt region to be displayed on the display section.
